(19) United States
(12) Patent Application Publication
(10) Pub. No.: US 2013/0117367 A1
(43) Pub. Date: May 9, 2013

(54) CONTENT RECOMMENDATION SYSTEM, RECOMMENDATION METHOD AND INFORMATION RECORDING MEDIUM RECORDING RECOMMENDATION PROGRAM

(71) Applicants: Chihiro Murakami, Tokyo (JP); Kyota Kanno, Tokyo (JP); Takashi Shiraki, Tokyo (JP); Tsunehisa Kawamata, Tokyo (JP); Kenshi Nishimura, Tokyo (JP)

(72) Inventors: Chihiro Murakami, Tokyo (JP); Kyota Kanno, Tokyo (JP); Takashi Shiraki, Tokyo (JP); Tsunehisa Kawamata, Tokyo (JP); Kenshi Nishimura, Tokyo (JP)

(73) Assignee: NEC CORPORATION, Minato-ku, Tokyo (JP)

(21) Appl. No.: 13/504,083

(22) PCT Filed: Sep. 17, 2010
(86) PCT No.: PCT/JP2010/066625

§ 371 Date: Jul. 18, 2012

(30) Foreign Application Priority Data
Oct. 26, 2009 (JP) 2009-245549

(51) Int. Cl. H04L 29/08

(52) U.S. Cl. CPC H04L 67/22
USPC 709/204

(57) ABSTRACT

There are included: a user mode presuming part 2 that presumes an individual reference value about a predetermined individual presumption item based on a user context which indicates a situation of a user and is included in a content recommendation request to calculate a user mode value; a recommendation part 3 that outputs a plurality of recommendation candidate contents extracted based on the user mode value; and a consolidating part 4 that selects and outputs as a recommendation content a predetermined number of contents from a plurality of recommendation candidate contents.

### TECHNICAL FIELD

The present invention relates to a content recommendation system, a recommendation method and an information recording medium recording a recommendation program.

### BACKGROUND ART

In recent years, there have been propositions to, by collecting and analyzing a plurality of pieces of information about actions of a user, presume information desired by the user under various situations (such as a season, time and a place), and recommend information desired by the user based on this presumed result.

For example, in Japanese Patent Application Laid-Open No. 2005-249606, an apparatus including a first selecting means for performing selection of various kinds of information using specific data and a second selecting means for performing further selection of the information selected by the first selecting means is disclosed. The specific data is information which is changed according to a situation of a user, and the first selecting means performs selection of various kinds of information by a selection condition including a plurality of rules set using the specific data. The second selecting means includes a digitization means and a comparison means, and further selects the information selected by the first selecting means. By selecting information at two stages in this way, information which seems to be desired by a user is selected.

Japanese Patent Application Laid-Open No. 2004-355075 discloses a probability network model which selects POI (Point of Interest) information which indicates a store and the like on a map according to the current position or the like of a user. Then, using this probability network model, a posteriori probability that each piece of POI information is selected is calculated, and POI information fitting in with a situation such as user's location is recommended based on a weight according to this posteriori probability.

Further, in Japanese Patent Application Laid-Open No. 2005-292904, a method to narrow contents down by determining a narrowing down standard of contents using a Bayesian net model including a plurality of content attributes of a presentation object is disclosed. A presentation object is searched for by applying a Bayesian net model to candidates that have been narrowed down.

### DISCLOSURE OF THE INVENTION

### Problems to be Solved by the Invention

However, in Japanese Patent Application Laid-Open No. 2005-249606, Japanese Patent Application Laid-Open No. 2004-355075 and Japanese Patent Application Laid-Open No. 2005-292904, recommendation of contents in consideration of user's various requesting states for information cannot be performed. Because a user cannot know a reference value of a recommended content, when a recommendation request is performed again, for example, it is not clear what kind of request should be made, and thus it is not convenient. For this reason, there is a problem that a system cannot perform efficient learning about recommendation processing.

Therefore, a main purpose of the present invention is to provide a content recommendation system and a recommendation method which can recommend contents in consideration of user's various requesting states for information and can perform efficient learning of recommendation processing by enabling a recommendation request to be performed efficiently even when a recommendation request is made again, and an information recording medium recording a recommendation program.

### Means for Solving the Problems

In order to solve the above-mentioned problems, a content recommendation system according to the present invention includes: a user mode presuming part to presume an overlap of individual reference values about predetermined individual presumption items as a user mode value about a user mode presumption item based on a user context indicating a user situation included in a content recommendation request; a recommendation part to output a plurality of recommendation candidate contents extracted based on the user mode presumption item; and a consolidating part to select and output as a recommendation content a predetermined number of contents from a plurality of the recommendation candidate contents based on the user mode value.

Also, a content recommendation method includes: a user mode presumption procedure to presume an individual reference value about a predetermined individual presumption item based on a user context indicating a user situation included in a content recommendation request, and calculate a user mode value about a user mode presumption item; a recommendation procedure to output a plurality of recommendation candidate contents extracted based on the user mode presumption item; and a consolidating procedure to select and output as a recommendation content a predetermined number of contents from a plurality of the recommendation candidate contents.

Further, an information recording medium recording a content recommendation program includes: a user mode presumption step to presume an individual reference value about a predetermined individual presumption item based on a user context indicating a user situation included in a content recommendation request, and calculate a user mode value about a user mode presumption item; a recommendation step to output a plurality of recommendation candidate contents extracted based on the user mode presumption item; and a consolidating step to select and output as a recommendation content a predetermined number of contents from a plurality of the recommendation candidate contents.

### Advantage of the Invention

As a result, because recommendation of contents in consideration of user's various requesting states for information becomes possible, and, when making a recommendation request again, it becomes possible to make the recommendation request easily because the recommendation request made once again can be performed by consulting an individual reference value.

Accordingly, a content recommendation system can learn recommendation processing efficiently.

### BRIEF DESCRIPTION OF THE DRAWINGS

FIG. 1 is a block diagram of a content recommendation system according to a first exemplary embodiment of the present invention.

FIG. 2 is a block diagram of a content recommendation system according to a second exemplary embodiment of the present invention.

FIG. 3 is a flow chart of a content recommendation system according to the second exemplary embodiment.

FIG. 4 is a diagram showing a structure of a content recommendation request outputted from a mobile terminal.

FIG. 5A is a diagram showing individual presumption items of a utilization purpose in a user mode presumption item presumed by a user mode presuming part.

FIG. 5B is a diagram showing individual presumption items of a usage area in a user mode presumption item presumed by a user mode presuming part.

FIG. 5C is a diagram showing individual presumption items of a recommendation method in an explanatory drawing of a user mode presumption item presumed by a user mode presuming part.

FIG. 6 is a diagram illustrating patterns of a user mode presumption item.

FIG. 7 is a diagram illustrating a utilization log list.

FIG. 8 is a diagram illustrating a utilization log list including a score.

FIG. 9 is a diagram illustrating a recommendation order.

FIG. 10 is a diagram illustrating a consolidating method of contents.

FIG. 11A is a diagram of a content screen which indicates a recommendation result in a screen shown on a mobile terminal.

FIG. 11B is a diagram of a mode designation screen in a screen shown on a mobile terminal.

FIG. 12 is a diagram illustrating a content recommendation request when a mode designation by a user has been performed.

FIG. 13 is a diagram illustrating a consolidating method of contents according to a third exemplary embodiment.

FIG. 14 is a block diagram of a content recommendation system according to a fourth exemplary embodiment.

FIG. 15 is a diagram illustrating a recommendation order.

### DESCRIPTION OF EMBODIMENTS

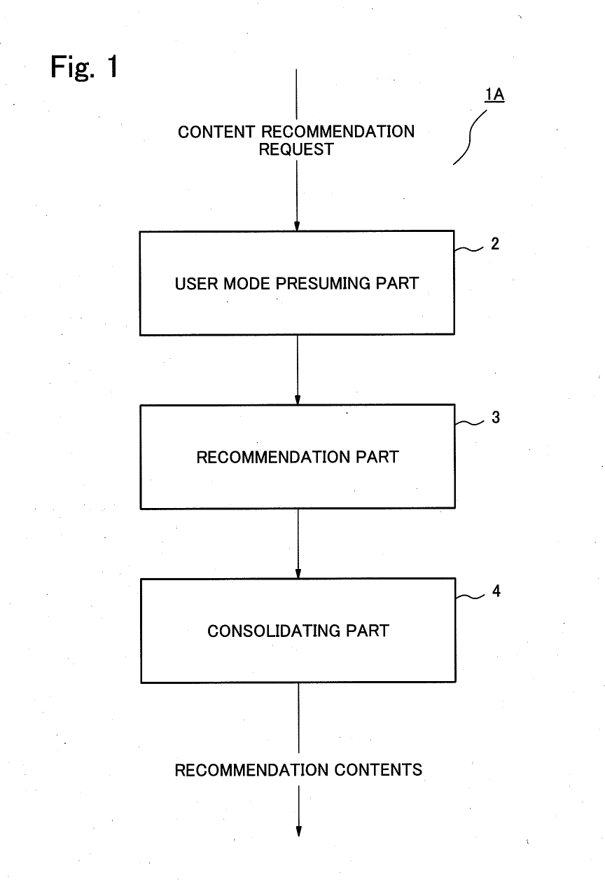

The first exemplary embodiment of the present invention will be described. FIG. 1 is a block diagram of a content recommendation system 1A according to this exemplary embodiment. The content recommendation system 1A includes a user mode presuming part 2, a recommendation part 3 and a consolidating part 4.

The user mode presuming part 2 presumes a predetermined individual presumption item based on a user context which is included in a content recommendation request and indicates a situation of a user, and calculates an individual reference value about this individual presumption item. Then, a user mode value about a user mode presumption item is calculated by individual reference values about a plurality of individual presumption items.

The recommendation part 3 outputs a plurality of recommendation candidate contents extracted based on the user mode presumption item.

The consolidating part 4 selects the predetermined number of contents from a plurality of recommendation candidate contents based on the user mode value, and makes it recommendation contents. The recommendation contents are outputted along with the individual presumption items and the individual reference values.

As a result, because the recommendation results are consolidated based on then user mode value which is an overlap of a plurality of individual reference values, contents in consideration of user's various requesting states for information can be recommended. In addition, because it is possible to make a recommendation request by consulting the individual reference values when a recommendation request is made again, a recommendation request which the user perform once again designating the individual reference values can be made easily. Accordingly, because a content recommendation system performs recommendation processing based on concrete individual reference values by a user and learns its result, recommendation processing becomes to be able to be learned efficiently.

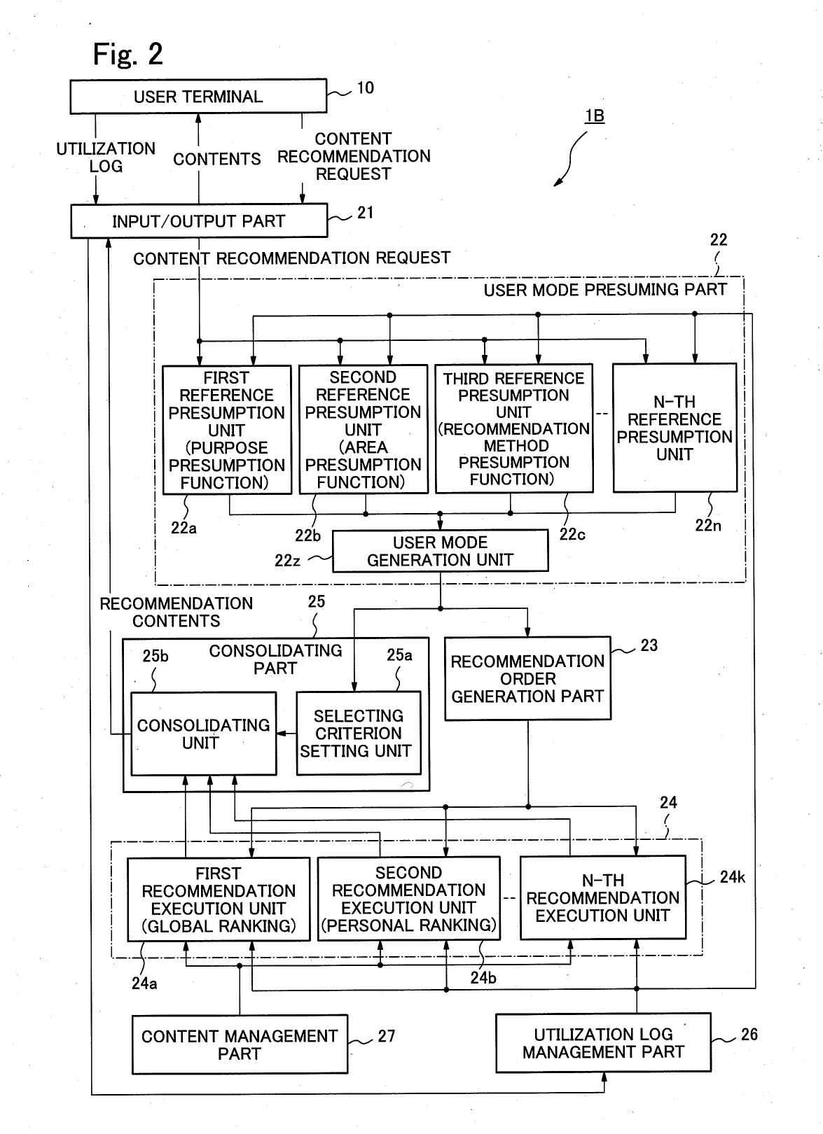

Next, the second exemplary embodiment of the present invention will be described. FIG. 2 is a block diagram of a content recommendation system 1B according to this exemplary embodiment. The content recommendation system 1B includes an input/output part 21, a user mode presuming part 22, a recommendation order generation part 23, a recommendation part 24, a consolidating part 25, a utilization log management part 26 and a content management part 27.

The user mode presuming part 22 includes a first to n-th reference presumption units 22a-22n that perform presumption about various individual presumption items such as a purpose of utilization and an area of usage based on a user context included in a content recommendation request, and output an individual reference value for each individual presumption item.

Meanwhile, an individual reference value is a numerical value of user's requesting state for information that has been presumed by a system about an individual presumption item. Because the system recommends contents based on this individual reference value, it is also related to a recommendation degree of contents.

That is, a user mode includes a plurality of user mode presumption items and user mode values. A user mode presumption item includes a plurality of individual presumption items, and an individual reference value is calculated to each individual presumption item. A user mode value is calculated based on all individual reference values.

In the followings, in order to simplify description, description will be made taking a case where a first to third reference presumption units 22a-22c are used, and an individual presumption item is assigned to each of the reference presumption units 22a-22c in advance as an example.

That is, it is supposed that: a function to presume for what purpose a user is requesting recommendation of contents as an individual presumption item (a purpose presumption function) is being assigned to the first reference presumption unit 22a; a function to presume about which area a user is requesting recommendation of contents as an individual presumption item (an area presumption function) is being assigned to the second reference presumption unit 22b; and a function to presume a recommendation method of recommendation of contents as an individual presumption item (a recommendation method presumption function) is being assigned to the third reference presumption unit 22c.

The user mode presuming part 22 includes a user mode generation unit 22z which calculates a user mode value about a user mode presumption item using individual reference values from each of the first to n-th reference presumption units 22a-22n. A user mode value is a numerical value made by a system presuming a degree of user's requesting state for information about a user mode presumption item representing the user's requesting state for information, and recommendation is performed based on this numerical value.

Based on a user mode presumption item, the recommendation order generation part 23 generates a recommendation order to make the, recommendation part 24 perform recommendation of contents. The recommendation part 24 includes a first to k-th recommendation execution units 24a-24k, and recommends contents based on a recommendation order from the recommendation order generation part 23. These contents are described as recommendation candidate contents.

In the followings, in order to simplify description, it is supposed that the first and second recommendation execution units 24a and 24b are used, and recommendation methods are being assigned to each of the recommendation execution units 24a and 24b in advance.

That is, it is supposed that a global ranking method by which, when contents are recommended, recommendation is performed in order of popularity of a content from highest to lowest is assigned to the first recommendation execution unit 24a, and a personal ranking method by which recommendation is made in order of correlation of a content to a set of contents which have been used by the requester of the recommendation from highest to lowest using publicly known collaborative filtering technology is assigned to the second recommendation execution unit 24b.

The consolidating part 25 includes a selecting criterion setting unit 25a and a consolidating unit 25b. Based on a user mode value, the selecting criterion setting unit 25a performs setting of a selecting criterion when selecting contents corresponding to the required number of contents from, recommendation candidate contents. The consolidating unit 25b performs consolidation by selecting contents from the recommendation candidate contents according to the selecting criterion from the selecting criterion setting unit 25a. Hereinafter, consolidated contents are described as recommendation contents. The recommendation contents as well as the individual reference values are transmitted to a user terminal via the input/output part 21.

By the aforementioned general configuration, the content recommendation system 1B receives a content recommendation request from a user terminal 10, and presumes a user mode value about a user mode presumption item based on a content recommendation request received in the user mode presuming part 22 and a utilization log stored in the utilization log management part 26. The user mode presumption item and the presumed user mode value about this user mode presumption item are sent to the recommendation order generation part 23, and a recommendation order is generated.

According to the user mode presumption item designated in the recommendation order, the recommendation part 24 extracts contents to be recommended from a large number of contents stored in the content management part 27 with reference to utilization logs stored in the utilization log management part 26, and sends them to the consolidating part 25 as recommendation candidate contents. The recommendation candidate contents are consolidated as recommendation contents based on the user mode value in the consolidating part 25. Then, the recommendation contents as well as the individual presumption items and the individual reference values are sent to the user terminal 10 via the input/output part 21.

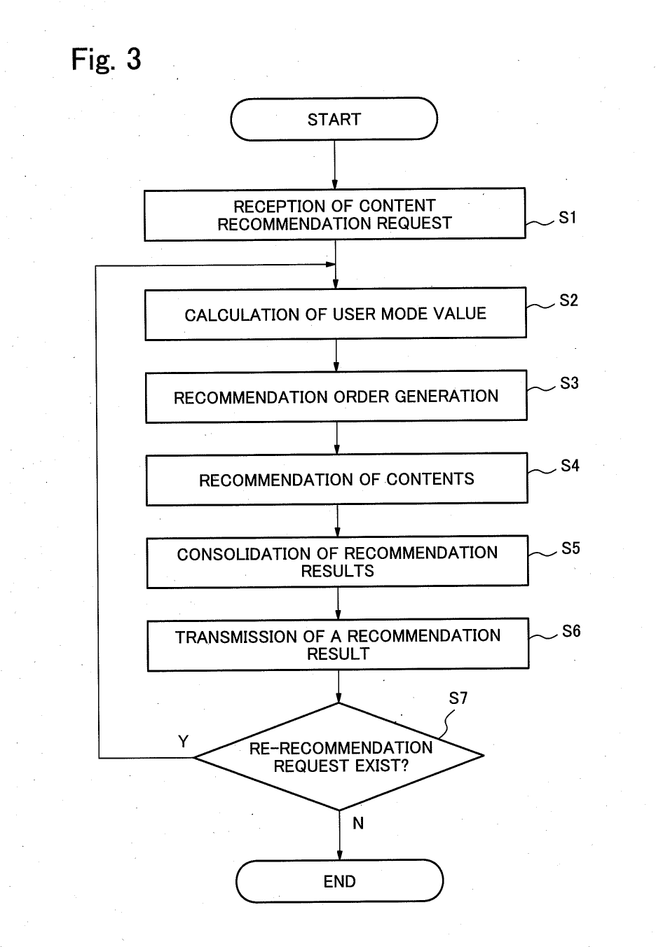

Hereinafter, a detailed structure and an operation of the content recommendation system 1B will be described according to flow chart shown in FIG. 3. On this occasion, description will be made supposing that, because a user wants to have a meal in Shinjuku, the user has made a content recommendation request intending to obtain recommendation of contents related to such information.

(1) Step S1: <Reception of a Content Recommendation Request>

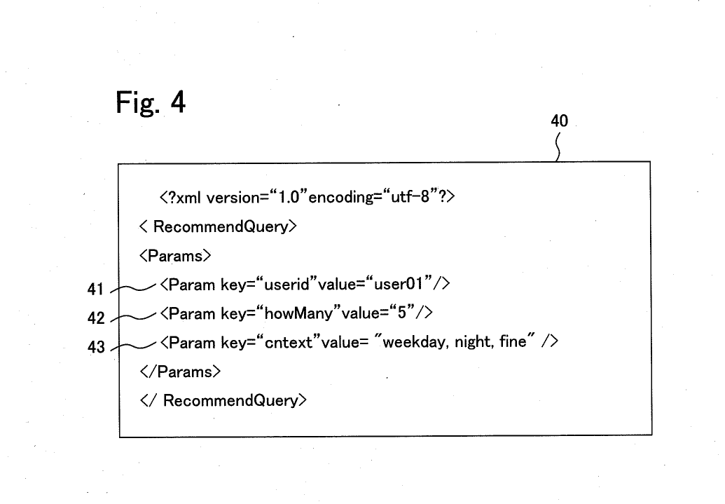

The user mode presuming part 22 receives a content recommendation request from the user terminal 10 via the input/output part 21. This content recommendation request has a structure as shown in FIG. 4, for example. That is, a content recommendation request 40 includes a user identifier 41 for identifying a user at least, the number of contents (the number of requested contents) 42 that the user requires and a user context 43.

The user context 43 includes no smaller than one piece of information such as a season, weekday/holiday, time, the area where a user exists at present (the current position), a user's movement direction, a user's action state (being at home, moving and the like), an age (age group) and a gender, for example. Of course, these may be illustration and it may include information besides these.

A user context is described as [C1, C2 . . . and Cn]. Here, n is a positive integer. In the following description, it is supposed that there are “weekday” and “holiday” as the contents of C1, and there are “morning”, “day” and “night” as the contents of C2, and there are “fine” and “cloudy” and “rain” as the contents of C3 , and [C1=weekday, C2=night and C3=fine] have been designated as the user context 43. In the user context 43 shown in FIG. 4, the user identifier 41 is “user01”, the requested number of contents 42 is “5”, and the user context 43 is “weekday, night, fine”.

(2) Step S2: <Presumption of a User Mode>

The content recommendation request is inputted to the first reference presumption unit 22a, the second reference presumption unit 22b and the third reference presumption unit 22c in the user mode presuming part 22. Then, individual reference values of a user's utilization purpose (individual presumption item) are presumed by the first reference presumption unit 22a, and individual reference values of a usage area (individual presumption item) where the user wants to achieve the utilization purpose are presumed by the second reference presumption unit 22b. Individual reference values of a recommendation method (individual presumption item) used by the recommendation part 24 are presumed by the third reference presumption unit 22c. These presumptions are calculated as a probability of a utilization purpose, a probability of a usage area and a probability of a recommendation method based on a user context according to Bayes's theorem indicated in formula (1), for example.

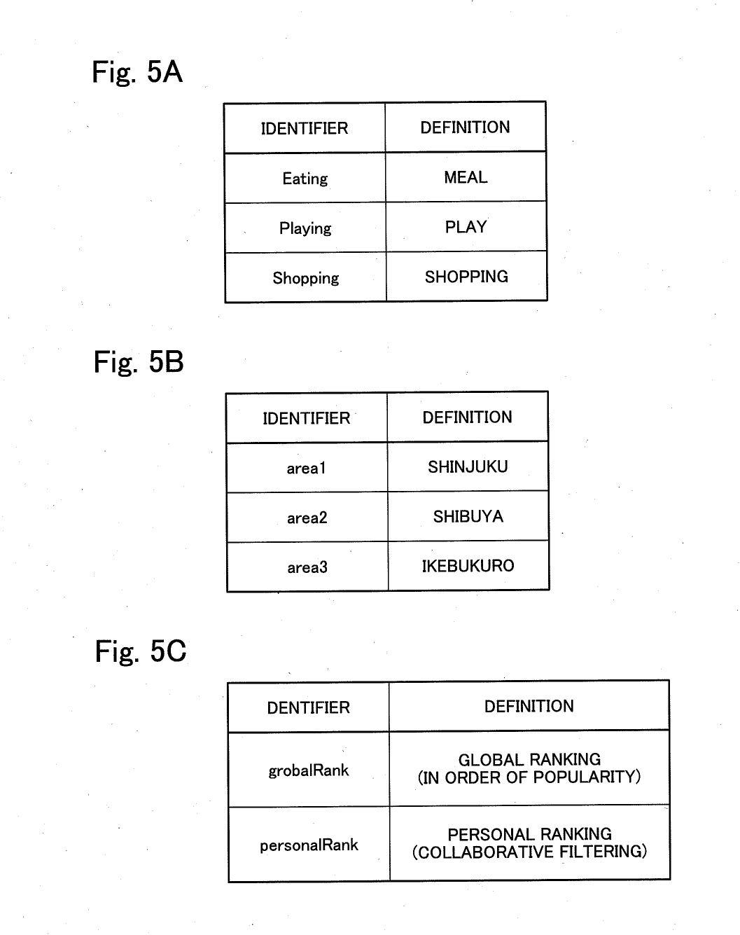

In the following description, it is supposed that there are “meal”, “shopping” and “play” as individual presumption items about a user's utilization purpose as shown in FIG. 5A, and there are “Shinjuku”, “Shibuya” and “Ikebukuro” as individual presumption items about a usage area as shown in FIG. 5B. It is also supposed that, as individual presumption items about a presuming method, there are “global ranking method”, “collaborative filtering method” as shown in FIG. 5C.

A combination of each detailed individual presumption item in each utilization purpose, each usage area and each recommendation method indicates one phenomenon. Accordingly, such phenomenon is defined as a user mode presumption item. A numerical value which has been made by the system presuming user's requesting state for information about a user mode presumption item is defined as a user mode value.

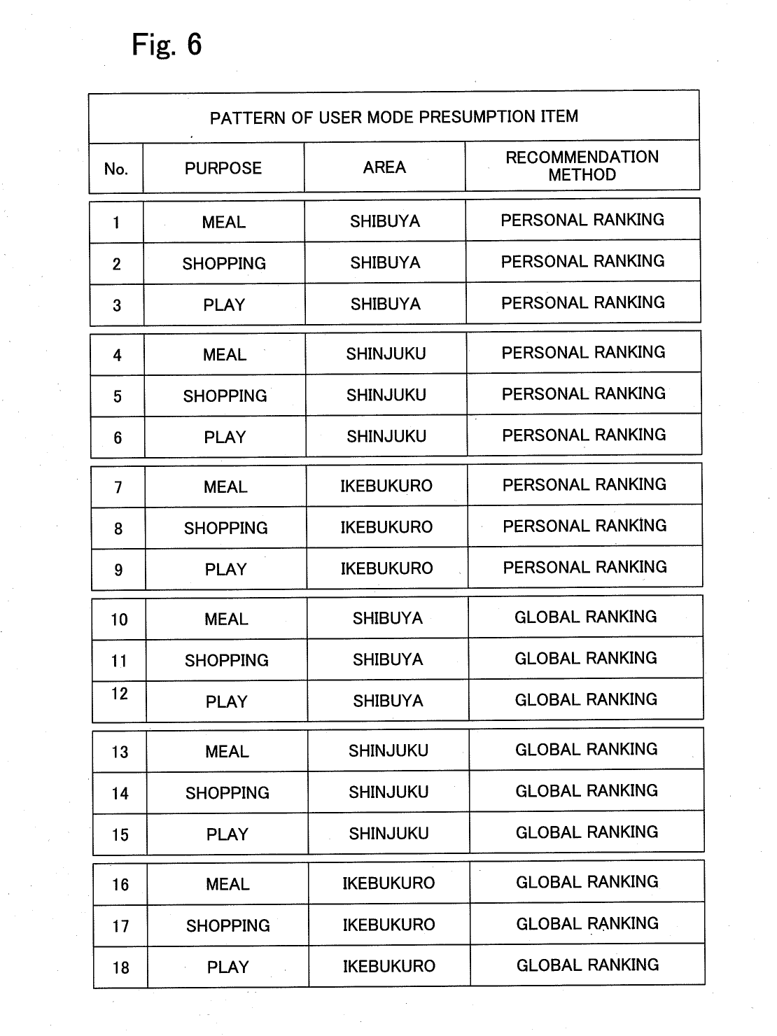

FIG. 6 is a diagram which illustrates a combination pattern of the detailed user mode presumption items mentioned above. Because there exist three patterns of a utilization purpose, three patterns of a usage area, two patterns of a recommendation method, 18 patterns (=3*3*2) of user mode presumption item patterns are being defined.

Meanwhile, in the following description, description will be made taking the case in which an individual presumption item such as a utilization purpose are set to a reference presumption unit in advance as an example. Such case is called explicit setting of an individual presumption item.

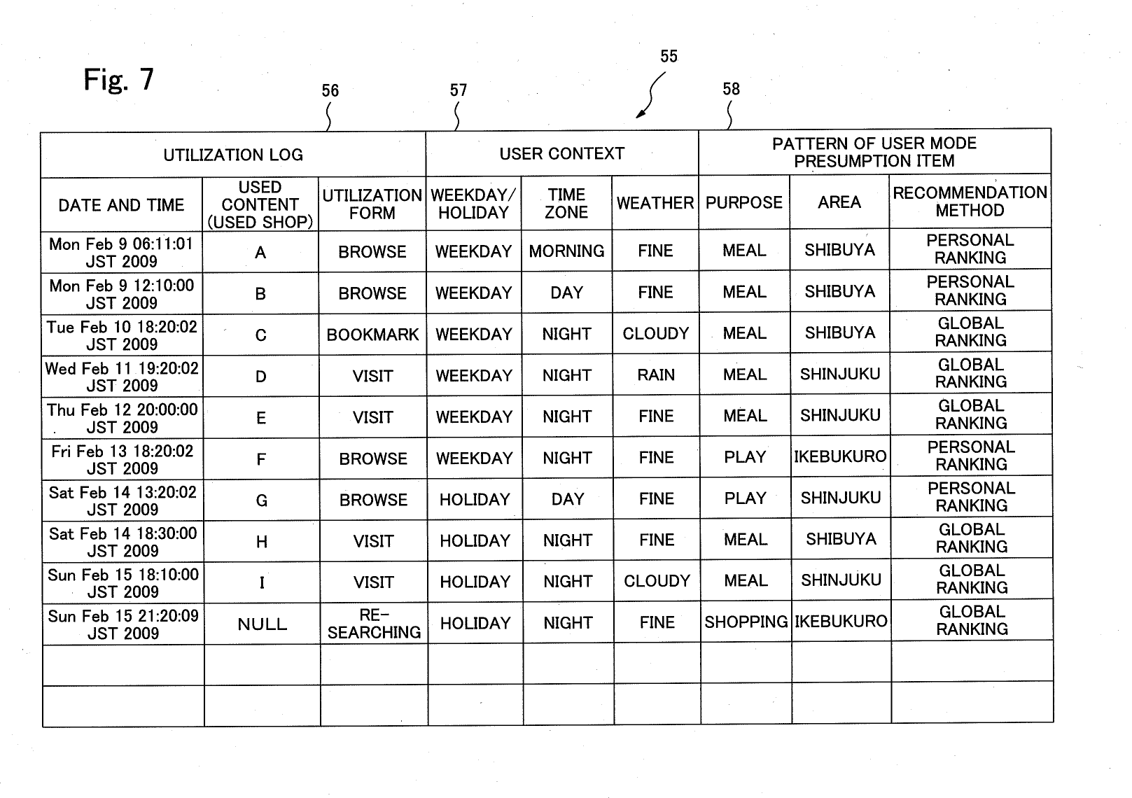

However, a method besides the explicit setting of an individual presumption item is also possible. For example, by clustering contexts similar to utilization logs as shown in FIG. 7 mentioned later, and allocating an individual presumption item to this cluster, an individual presumption item can be set. Such setting of an individual presumption item is called implicit setting.

Now, a utilization log list 55 shown in FIG. 7 indicates information about the content of a content recommendation request performed in the past, a recommendation history and a utilization history, and includes a utilization log field 56, a user context field 57 and a user mode field 58.

The utilization log field 56 is a data field which indicates a usage status in the past such as “the date and time, a content that has been used and a utilization form”. A user context field is a field which indicates a user context such as “weekday/holiday, a time zone and weather” included in a content recommendation request. An user mode field is “a purpose, area and recommendation method” and the like.

For example, the first line of the utilization log list 55 has the following contents. Because an condition of “weekday, morning, fine” had been included in the user context 57, the content recommendation system 1B presumed, from this user context 57, a user mode value about a user mode presumption item constituted of the user's utilization purpose of “meal”, a usage area of “Shibuya”, a recommendation method of “personal rank”. Then, as a result of recommendation of contents as many as the requested number of contents included in a content recommendation request based on the user mode value about this presumed user mode presumption item, the user “browsed” the home page or the like of store “A” on “Monday, Feb. 9, 2009, at 6:11:1 Japan Standard Time”.

Meanwhile, in the utilization log of the last line in FIG. 7, the used content is “NULL value”, and the utilization form is “re-searching”. This means that, about the content recommended once, a content recommendation request was performed again because the user was not satisfied by this recommended content. Thus, because a content recommendation system can recognize that it is a utilization log for which re-searching is requested, suitability or unsuitability of an individual reference value which has been used for content presumption related to a re-searching request becomes to be able to be judged. Accordingly, learning of recommendation processing can be done efficiently.

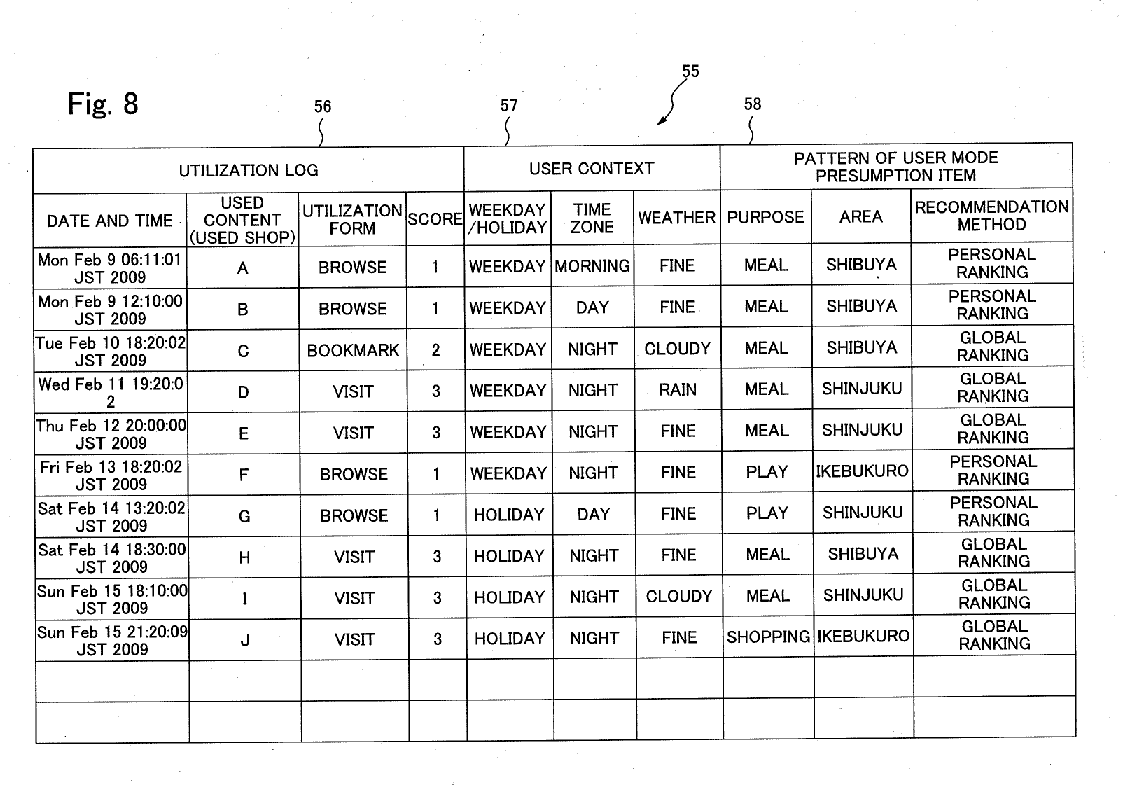

As shown in FIG. 8, a score field may be provided in the utilization log field 56. A numerical value of the score field (score) is set according to a utilization form of information such as “browse, bookmark and visit”: as “1” in the case of “browse”, “2” in the case of “bookmark” and “3” in the case of “visit”. An individual reference value about an individual presumption item and a user mode value about a user mode presumption item may be calculated using this score.

Now, when it is supposed that, by Naive Bayes (Naive Bayes), context C1j1 . . . Cnjn are independent, following formula (1) mentioned above, an individual reference value of a utilization purpose is given by formula (2) and an individual reference value of a usage area by formula (3) and an individual reference value of a recommendation method by the formula (4). Individual reference values about a utilization purpose, a usage area and a recommendation method obtained by these formulas are sent to the user mode generation unit 22z, and a user mode value is generated following formula (5) by this user mode generation unit 22z. As mentioned above, on this occasion, an obtained numerical value is a probability because each presumption makes Bayes's theorem a basis. Accordingly, a user mode value is also a probability numerical value.

The formula (5) is a product of all of formula (2)-formula (4). That is, a user mode value is given by multiplying a purpose individual reference value, an area individual reference value and a recommendation method reference value. At that time, it is supposed that each individual reference value is independent. That is, a utilization purpose and a usage area and the like are supposed to be independent events.

For example, it means that, when a user wants to have “meal” in “Shinjuku”, it is supposed that “Shinjuku” and “meal” are independent. In reality, it cannot declare that a utilization purpose and a usage area are independent events, and they are often dependent events. However, when supposing that individual presumption items of a utilization purpose and a usage area like “Shinjuku” and “meal” are dependent events, there can happen a case where the number of utilization logs which include them together is very small. In such cases, it becomes impossible to recommend contents of the number which satisfies the requested number of contents. Accordingly, by supposing as independent events, such inconvenience is being prevented.

Of course, when a large number of utilization logs have been accumulated, recommendation of contents of the number which satisfies a request becomes possible even in a case of dependent events. Accordingly, it may be such that, when the accumulated number of utilization logs is small like a start-up time of a system, a user mode value is calculated supposing that individual presumption items are independent, and, when a large number of utilization logs have been accumulated, a user mode value is calculated supposing that individual presumption items are dependent.

Also, it may be such that, although a user mode value is calculated supposing as independent in a default status, when a content recommendation request is made again, it is supposed as being dependent, and a user mode value is calculated using a joint probability of respective individual presumption items or a conditional probability.

Further, in the above-mentioned description, although an individual reference value and a user mode value are obtained by performing presumption calculation processing when a content recommendation request is received, in a case where individual presumption items are assigned in advance, it is also possible to calculate and obtain all individual reference values and user mode values beforehand.

In this case, recommendation processing is performed using individual reference values and user mode values which are calculated on the conditions which accord with a user context included in the content recommendation requests that have been received. In the case where all individual reference values and user mode values are calculated and obtained beforehand, there is an advantage that contents can be recommended in a shorter time than a case calculation is performed after receiving a content recommendation request. The reason of this is that a plurality of user mode values are needed to be calculated when contents are recommended, and it is very time-consuming.

(3) Step S3: <Recommendation Order Generation>

A user mode value about a user mode presumption item calculated by the above is sent to the recommendation order generation part 23. The recommendation order generation part 23 generates a recommendation order for the recommendation part 24 based on a user mode presumption item.

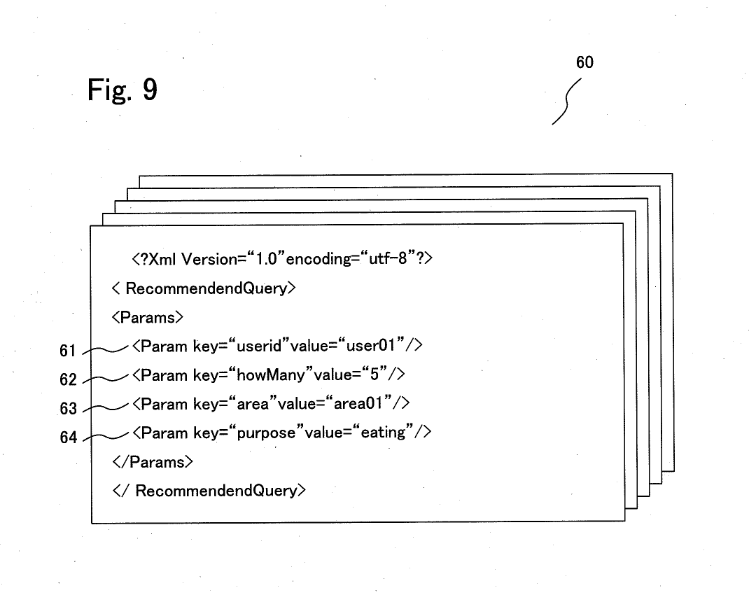

FIG. 9 is an example of a generated recommendation order. A recommendation order 60 includes a user identifier 61 and a requested contents count 62, an area individual reference value 63 and a purpose individual reference value 64.

(4) Step S4: <Recommendation of Contents>

According to a recommendation order received from the recommendation order generation part 23, the recommendation part 24 sets contents to be extracted with reference to a user mode presumption item included in a recommendation order and a utilization log list stored in the utilization log management part 26, and performs extraction from contents stored in the content management part 27 according to this setting. Contents which has been extracted and recommended are sent to the consolidating part 25 as recommendation candidate contents.

At that time, the first recommendation execution unit 24a recommends contents according to the global ranking method, and the second recommendation execution unit 24b recommends contents according to the collaborative filtering method. The number of recommendation candidate contents recommended by each of the recommendation execution units 24a and 24b is the number no smaller than the requested number of contents, respectively.

Meanwhile, the global ranking method refers to a utilization log list shown in FIG. 8, for example, and performs extraction as many as the requested number of contents in order of total score from highest to lowest (order of popularity) that have been obtained from utilization logs having a same user mode presumption item (including approximately same cases).

The personal ranking method recommends contents using a collaborative filtering technology. For example, in a collaborative filtering technology using a correlation coefficient method, among utilization logs which accord (including approximately same cases) with a user mode presumption item, correlation between a set of contents which a recommendation requester has used and a set of all contents is calculated by agreement of a utilization form of contents (a user who has used a content), and a score is given in order of correlation from highest to lowest. Then, contents with high correlation values are extracted as many as the requested number of contents.

(5) Step S5: <Consolidation of Recommendation Results>

When the consolidating part 25 receives a plurality of recommendation candidate contents from the first to k-th recommendation execution units 24a-24k, the selecting criterion setting unit 25a sets a selecting criterion when selecting contents of the requested number of contents from the recommendation candidate contents. Description will be made later of this setting method.

The consolidating unit 25b selects contents from the recommendation candidate contents according to the selecting criterion, and makes them be recommendation contents.

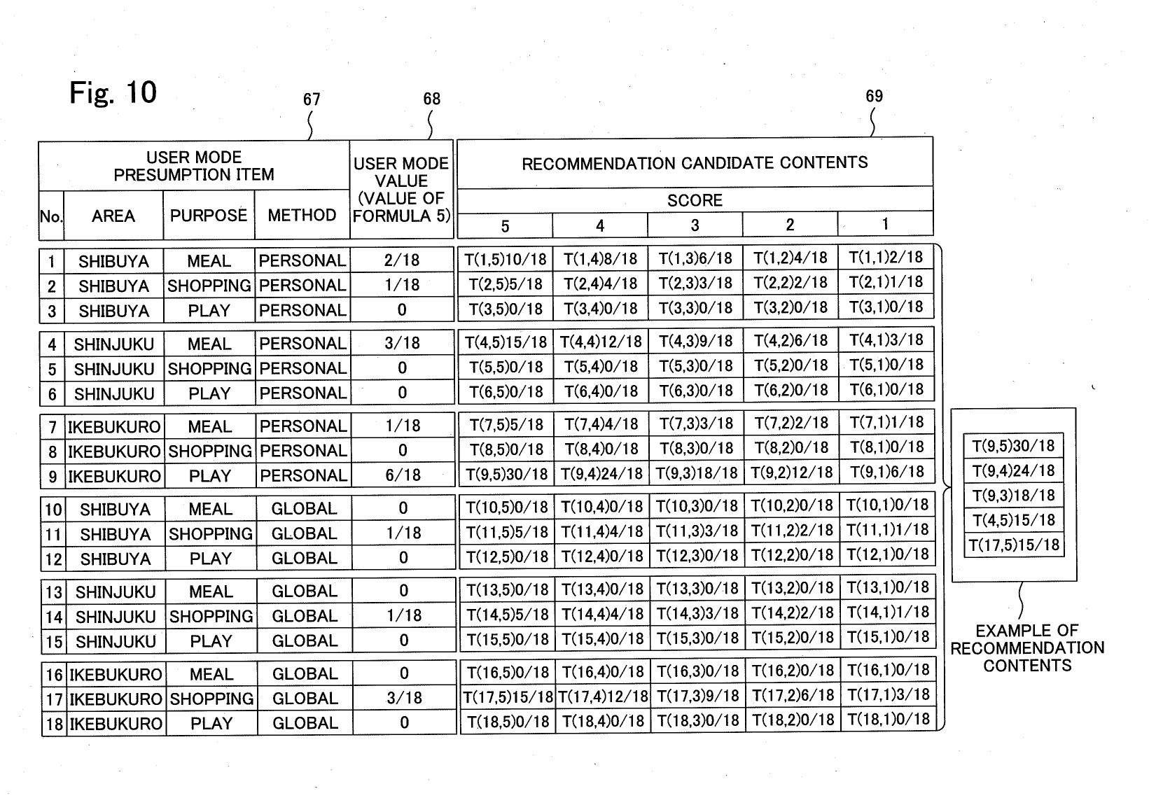

FIG. 10 is a diagram which indicates a user mode value (a numerical value of formula (5)) 68 and recommendation candidate contents 69 about each user mode presumption item 67. Meanwhile, a recommendation candidate content is described as T (k, j). In this content T (k, j), “k” shows the number of a user mode, and “j” indicates the score in the recommendation candidate contents of this user mode. Accordingly, the horizontal line of a content T (k, j) indicates recommendation candidate contents about one user mode, and they are indicated in order of score from highest to lowest.

Meanwhile, when the ranges of numerical values of scores of recommendation candidate contents in each user mode are different, the ranges of the score values need to be made equal by normalizing or the like in order of scores from highest to lowest. For simplification, it is supposed that numerical values of 5, 4, 3, 2 and 1 are given to scores of recommendation candidate contents of all user modes in order of score from highest to lowest.

Because there exist 18 patterns of user modes and the requested number of contents is “5”, five contents have to be selected from a group of the total number of 90 (=18*5) contents that have been recommended. It is possible to think that a user mode value corresponds to a degree that information about a user mode presumption item is needed by a user. Accordingly, contents of a quantity corresponding to this user mode value are extracted.

The criterion for determining this extraction is a selecting criterion. Selecting criterion is defined by γ=user mode valuer score. Selection is made in order of such selecting criterion from largest to lowest as many as the requested number of contents. This selecting criterion is described beneath T (k, j) in FIG. 10. In order of numerical values of a selecting criterion from largest to smallest, contents of T (9, 5) with γ= 30/18, T (9, 4) with γ= 25/18, T (9, 3) with γ=18/18, T (4, 5) with γ= 15/18 and T (17, 5) with γ= 15/18 are selected.

(6) Step S6: <Transmission of a Recommendation Result>

After consolidating contents, the consolidating part 25 transmits consolidated contents (recommendation contents) as well as the user context and the user modes to a user terminal 21 via the input/output part 21. On this occasion, the individual presumption items and the individual reference values are also transmitted to the user terminal 10 along with the recommendation contents.

(7) Step S7: <Confirmation of Contents>

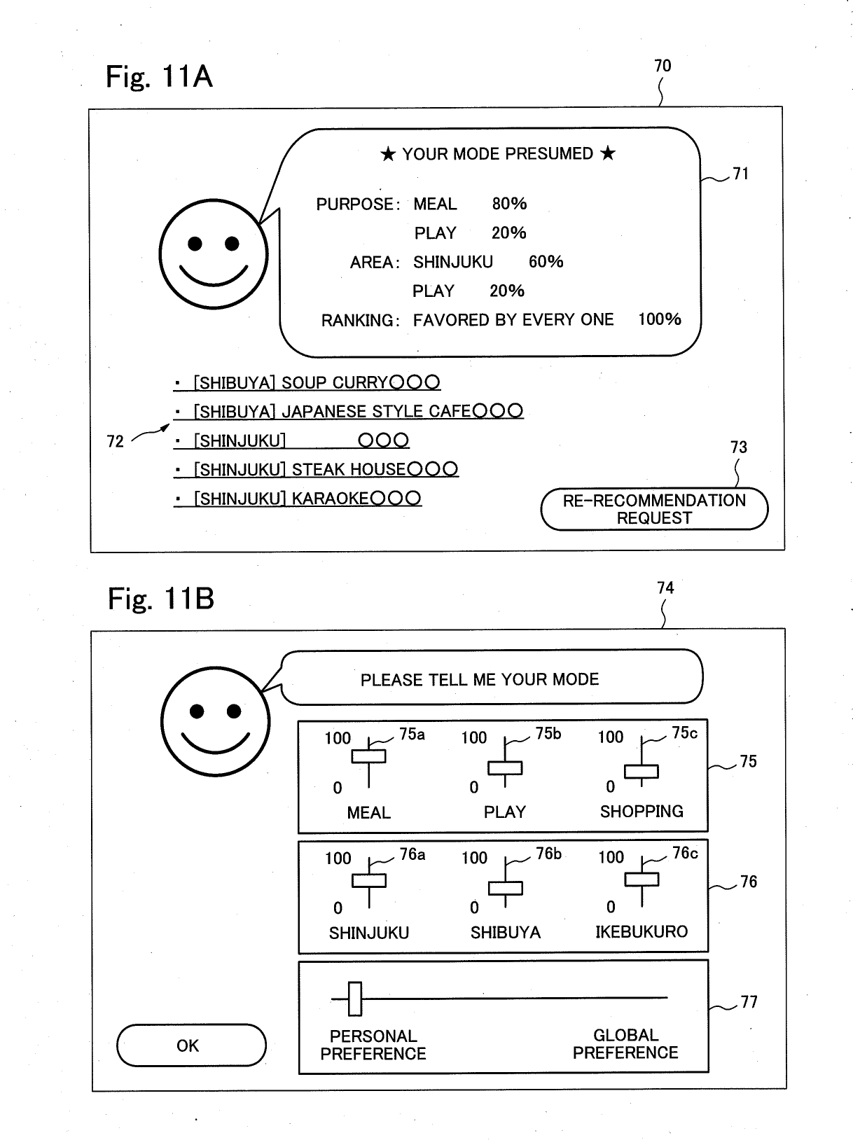

A content screen as shown in FIG. 11A is shown to the user terminal 10 that has received recommendation contents. FIG. 11A indicates a content screen 70. The content screen 70 includes a mode display column 71 which indicates individual reference values (numerical values of formula (2)-formula (4)) of a utilization purpose, a usage area and a recommendation method that have been presumed, and an information column 72 which indicates recommendation contents.

FIG. 11A means that, about a user context, contents that have been recommended on a condition that a purpose individual reference value related to a meal is 80%, a purpose individual reference value related to play is 20%, an area individual reference value related to Shinjuku is 60%, an area individual reference value related to Shibuya is 40% and global ranking method (everyone is fond of) between recommendation methods is 100% are indicated in an information column 72.

Thus, because, when recommendation contents are indicated, individual reference values such as purpose individual reference values and area individual reference values which the content recommendation system 1B has presumed are also indicated, a user can know individual reference values of the contents clearly.

Meanwhile, Shibuya and the like may be indicated by transmitting a position code from a system and converting this position code into a Japanese notation such as Shibuya in the side of a mobile terminal. When the recommendation content shown in the information column 72 are not satisfied sufficiently, move to a mode designation screen shown in FIG. 11B can be done by pushing down a re-recommendation request button 73 including a touch button and the like.

In a mode designation screen 74 which is indicated by pushing down the re-recommendation request button 73, there are provided an input column 75 about a utilization purpose, an input column 76 about a usage area and an input column 77 about a recommendation method. Each of the input columns 75-77 are of a touching method in which an instruction is made by sliding a slide button.

Numerical values set to each of the input columns 75-77 are numerical values corresponding to a purpose individual reference value, an area individual reference value and a recommendation method reference value. Accordingly, when the user performs input designation of each numerical value and presses the OK button, the designated numerical values are transmitted to the content recommendation system 1B. At that time, when an input value about “meal” is set to “100” (specifically, the slide button is brought close to the position of “100”), for example, the purpose individual reference value about a meal is set to “100%”. Conversely, when an input value about “meal” is set to “0” (specifically, the slide button is brought close to the position of “0”), the purpose individual reference value about a meal is set to “0%”. Each numerical value set in this way is sent to the content recommendation system 1B.

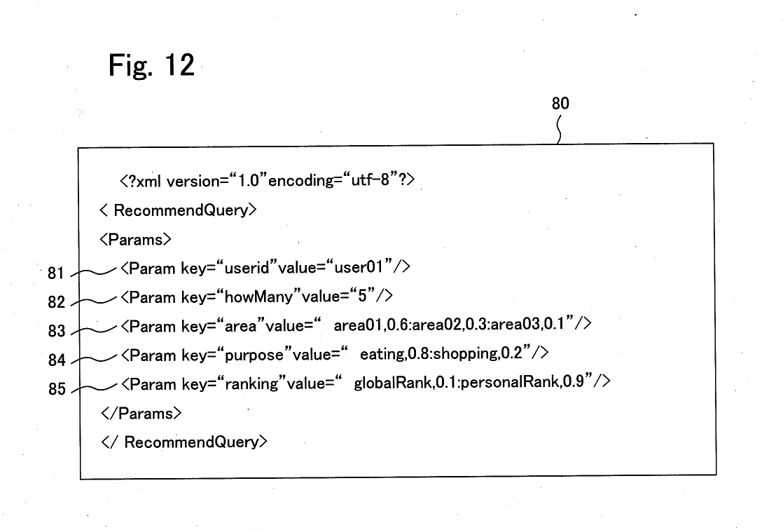

FIG. 12 is a diagram showing a re-content-recommendation request 80 including each inputted numerical value. This re-content-recommendation request 80 includes a user identifier 81 for identifying a user at least, the number of contents (the requested number of contents) 82 requested by the user, an area designation value 83, a purpose designation value 84 and a recommendation method designation value 85.

Because numerical values corresponding to an area individual reference value and a purpose individual reference value are included in the re-content-recommendation request 80, presumption processing in the first to n-th reference presumption units 22a-22n is not performed by the content recommendation system 1B, and these are inputted to the user mode generation unit just as it is to generate a user mode value.

Thus, because a user can designate each numerical value by making reference to indicated purpose individual reference values, designation becomes easy. This means that efficient learning becomes possible for the content recommendation system 1B.

Next, the third exemplary embodiment of the present invention will be described. Meanwhile, about the same structures as the second exemplary embodiment, description will be omitted appropriately using identical codes.

In the second exemplary embodiment, the method in which, when recommended contents are consolidated by the consolidating part, a selecting criterion is defined as a product of a user mode value of formula (5) and a score (γ=user mode value×score), and selection is made as many as the requested number of contents in order of this selecting criterion from largest to smallest has been described.

In this case, there are no cases that contents which have been recommended about a user mode with a small numerical value of a user mode value are selected. For example, contents of a user mode value of 1/18 in FIG. 10 are not selected if there exist a larger number of user mode values with numerical values larger than that value than the requested number of contents.

However, unless a user context which is a calculation parameter changes, a user mode value does not change. This is a desirable thing from a view point of stability of a system (reproducibility of recommendation contents). However, because it cannot be said that the user's request is being followed completely because a user mode value is a presumed value, there is a case where some unpredictability is desired rather than completely requiring reproducibility of recommendation contents. That is, because, even if a user mode value is “ 1/18”, it is not “0”, they may include contents which the user is searching for. Also, when reproducibility of recommendation contents is emphasized, fixation of a recommendation content may occur.

Therefore, according to this exemplary embodiment, in order to include a possibility that even contents of a small user mode value are selected and in order to prevent fixation of recommendation contents by bringing a uncertainty element into a consolidating method of recommended contents, a selecting criterion is set in the selecting criterion setting unit 25a.

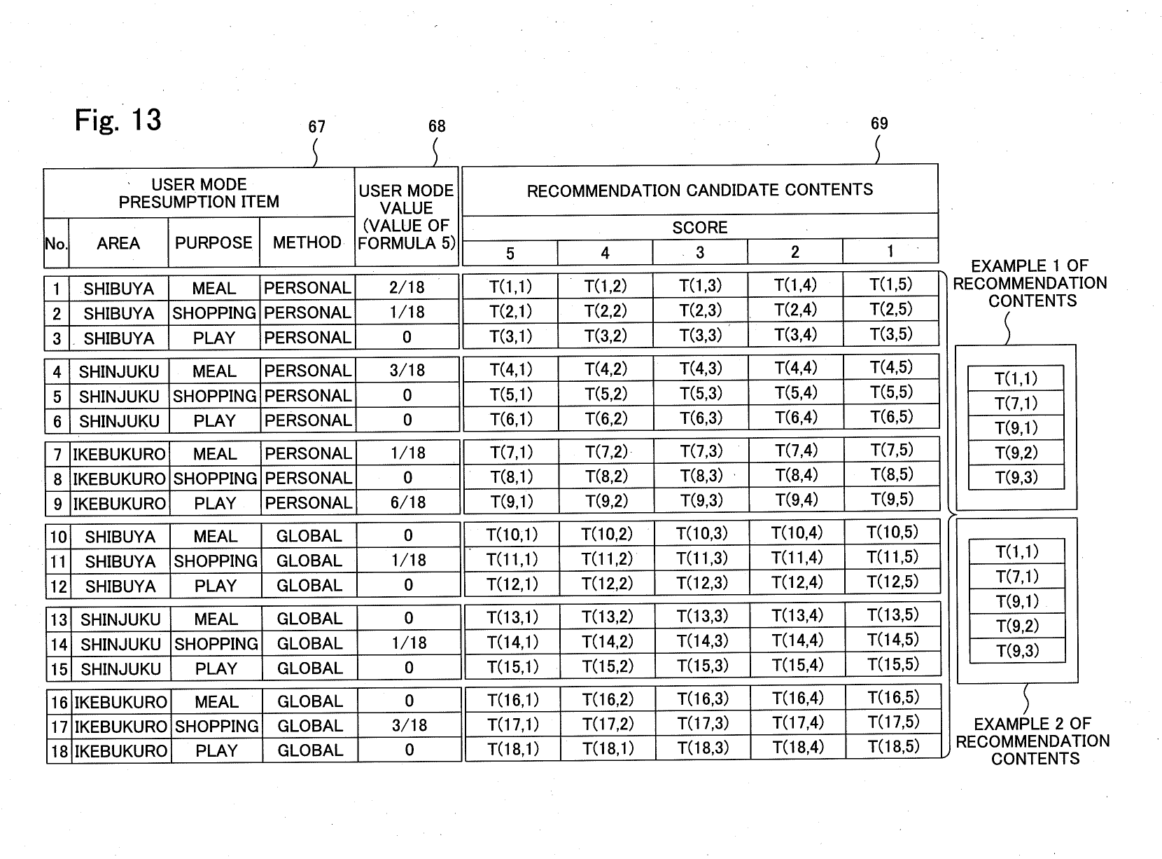

FIG. 13 is a diagram illustrating a consolidating method in which recommendation candidate contents are consolidated according to such selecting criterion. Because the total number of the user modes is 18, an indexed table with the size of 18 is prepared. Because the user mode value of the user mode number “1” is 2/18, the user mode number “1” is correlated to two areas in the table. Similarly, because the user mode value of the user mode number “2” is 1/18, the user mode number “2” is correlated to one area in the table. Because the user mode value of the user mode number “3” is 0/18, a user mode is not correlated to an area in the table in this case.

Next, by a random number generator which generates integers of 1-18 with same probabilities, any of numerical values of 1-18 is obtained.

About a generating method of a random number, a known method such as a mixed congruent method is used, and a generation algorithm thereof does not matter. Using a numerical value of 1-18 obtained in this way as an index, one user mode is acquired from the indexed table where user modes are assigned, and, from a content group corresponding to a correlated user mode number, recommendation candidate contents are determined in order of score. Thus, a recommendation candidate content is extracted in turn until a recommendation required number is reached. Accordingly, selection of a recommendation candidate content of a user mode of a small user mode value also becomes possible, and, as a result, fixation of a recommendation content can be prevented.

Next, the fourth exemplary embodiment of the present invention will be described. Meanwhile, description will be omitted appropriately using an identical code about a same structure as the second and third exemplary embodiments.

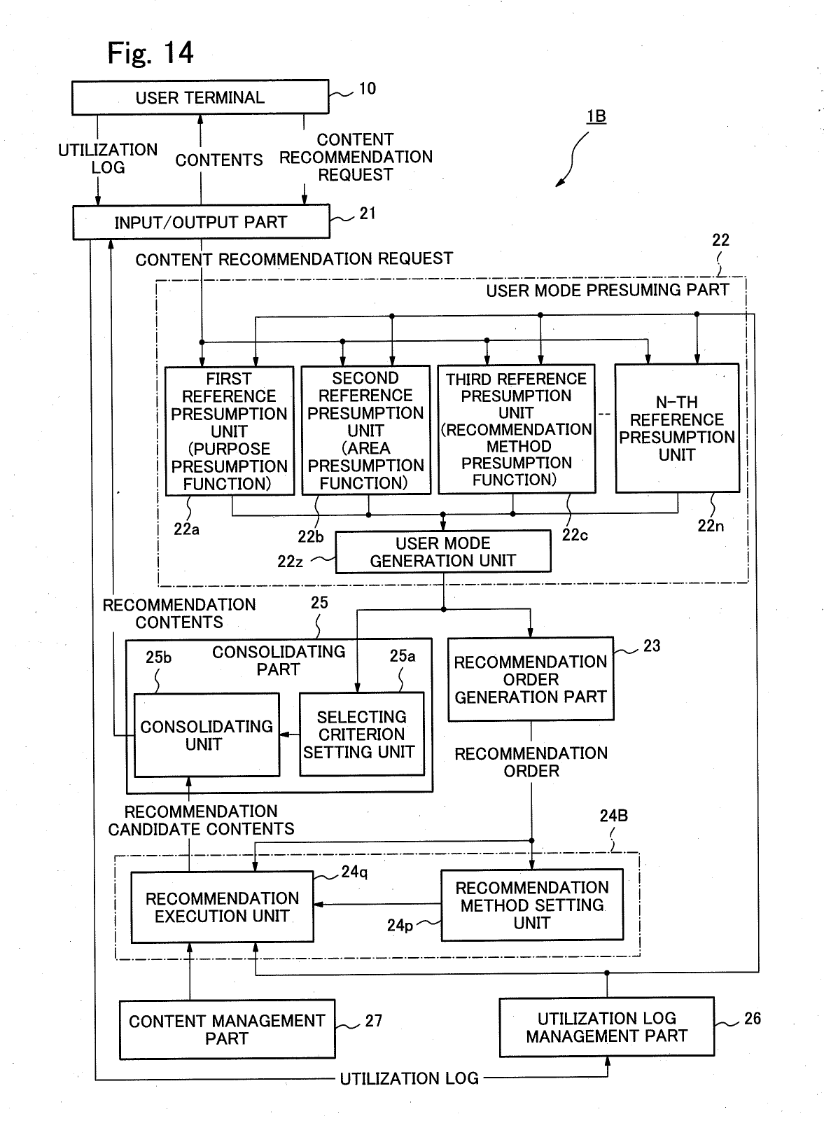

In the exemplary embodiments described in the above, the recommendation part 24 includes a plurality of recommendation execution units in advance. In contrast, in this exemplary embodiment, as shown in FIG. 14, a recommendation part 24B includes one recommendation execution unit 24q and a recommendation method setting unit 24p which sets a recommendation method carried out by this recommendation execution unit.

At that time, the recommendation method setting unit 24p sets a recommendation method to the recommendation execution unit 24q according to a recommendation request outputted from the recommendation order generation part 23.

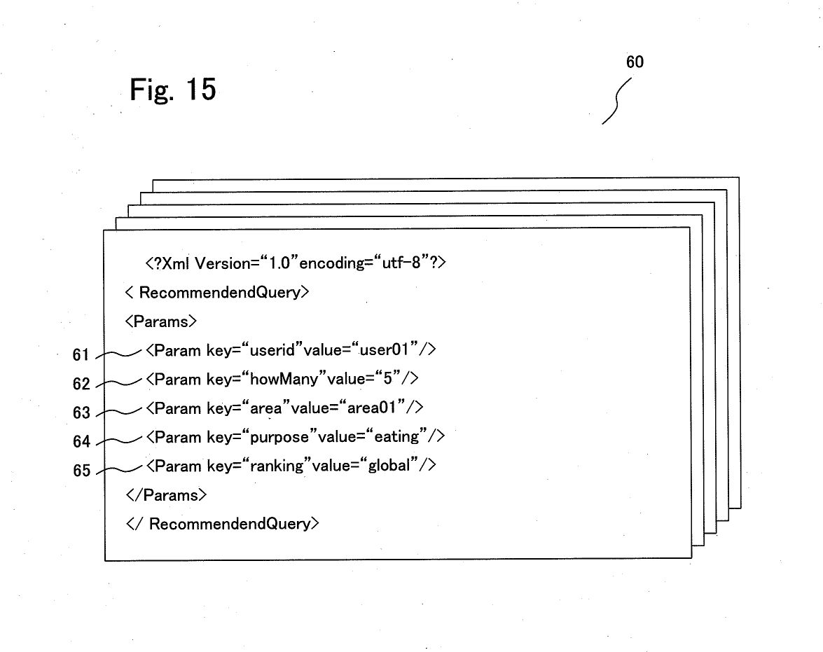

An example of a recommendation request outputted from the recommendation order generation part 23 is shown in FIG. 15. A recommendation method reference value 65 which designates a recommendation method is included in the recommendation order shown in FIG. 15. Accordingly, the recommendation method setting unit 24p makes the recommendation execution unit 24q be equipped with a recommendation method to be made to function according to this recommendation method reference value. Specifically, the processing procedure of this recommendation method is installed in the recommendation execution unit. As a result, the recommendation execution unit 24q recommends contents according to the equipped processing procedure.

Meanwhile, although the recommendation method reference value 65 included in the recommendation order shown in FIG. 15 designates only a global recommendation method, a plurality of recommendation methods may be designated as shown in FIG. 12. As a result, a plurality of recommendation methods become able to be carried out by one recommendation execution unit, and it becomes possible to provide an inexpensive system.

Meanwhile, it is possible to make a program by coding a recommendation method mentioned above in a computer-executable manner, and such program can also be recorded in an information recording medium.

Although the present invention has been described with reference to each exemplary embodiment above, the present invention is not limited to the above-mentioned exemplary embodiments and examples. Various changes which a person skilled in the art can understand can be made in the composition and details of the present invention within the scope of the present invention.

This application claims priority based on Japanese application Japanese Patent Application No. 2009-245549, filed on Oct. 26, 2009, the disclosure of which is incorporated herein in its entirety.

### DESCRIPTION OF SYMBOLS

1A, 1B Content recommendation system
2 User mode presuming part
3 Recommendation part
4 Consolidating part
10, 21 User terminal
22 User mode presuming part
22a-22n First to n-th reference presumption units
22z User mode generation unit
23 Recommendation order generation part
24 Recommendation part
24B Recommendation part
24a First recommendation execution unit
24b Second recommendation execution unit
24p Recommendation method setting unit
24q Recommendation execution unit
25 Consolidating part
25a Selecting criteria setting unit
25b Consolidating unit
26 Utilization log management part
27 Content management part
40 Content recommendation request
41 User identifier
43 User context
55 Utilization log list
70 Content screen
74 Mode designation screen

1-35. (canceled)

36. A content recommendation system which recommends contents based on a content recommendation request from a user, comprising:
a user mode presuming part which presumes a predetermined individual presumption item based on a user context indicating the user situation included in the content recommendation request, and calculates a user mode value about a user mode presumption item by calculating an individual reference value about the presumed individual presumption item;
a recommendation part which outputs a plurality of recommendation candidate contents extracted based on the user mode presumption item; and
a consolidating part which selects the contents of a predetermined number of contents from a plurality of the recommendation candidate contents based on the user mode value, and outputs as a recommendation content.

37. The content recommendation system according to claim 36, wherein the user mode presuming part comprises:
a reference presumption unit which presumes the individual reference value; and
a user mode generation unit which calculates the user mode value about the user mode presumption item from a plurality of the individual reference values.

38. The content recommendation system according to claim 37, wherein
a plurality of the reference presumption units are provided, and each of the reference presumption units presumes the individual reference value about the individual presumption item being different.

39. The content recommendation system according to claim 37, wherein
the user mode generation unit generates the user mode value about the user mode presumption item based on the individual reference value about a plurality of the individual presumption items.

40. The content recommendation system according to claim 37, wherein
different one of the individual presumption items is assigned in advance for each the reference presumption unit.

41. The content recommendation system according to claim 37, further comprising:
an individual presumption item allocation unit which extracts the individual presumption item from a user log in a past and allocate an extracted individual presumption item to the reference presumption unit.

42. The content recommendation system according to claim 37, wherein
the recommendation part adds a recommendation degree as a score when recommending contents according to the user mode presumption item.

43. The content recommendation system according to claim 42, wherein
the recommendation part has a plurality of recommendation execution units which recommends contents; and
a recommendation method used when recommending contents is set in advance as each recommendation execution unit.

44. The content recommendation system according to claim 42, wherein the recommendation part comprises:
a recommendation execution unit which recommend contents; and
a recommendation method setting unit which set a recommendation method when the recommendation execution unit recommending contents according to the user mode presumption item.

45. The content recommendation system according to claim 42, wherein the recommendation part comprises:
a plurality of recommendation execution units which recommend contents; and
a recommendation method setting unit which set a different recommendation method for each of the recommendation execution units according to the user mode presumption item.

46. The content recommendation system according to claim 42, wherein the consolidating part further comprises:
a selecting criteria setting unit which set a selecting criterion when selecting contents of a requested number of contents requested by the user from the recommendation candidate contents; and
a consolidating unit which selects and consolidates contents from the recommendation candidate contents according to the selecting criterion.

47. The content recommendation system according to claim 46, wherein
setting of the selecting criterion is setting to make the user mode be selected by, when making the user mode correlate with each area of an indexed table having a number of areas corresponding to a total number of the user modes, making the areas of a quantity corresponding to the user mode value correlate with the same user mode, and making random numbers of an integer be generated with an equally probability taking a total number of the user modes as a range.

48. The content recommendation system according to claim 46, wherein
setting of the selecting criterion is setting to, taking a product of the user mode value and the score given to a content as the selecting criterion, make a content with the selecting criterion being larger be selected.

49. The content recommendation system according to claim 36, wherein,
when a mobile terminal indicates the recommendation content, the consolidating part outputs the individual presumption item and the individual reference value with the recommendation content so that the individual presumption item and the individual reference value are also indicated.

50. The content recommendation system according to claim 49, wherein,
upon receiving the content recommendation request including a designated individual reference value corresponding to the individual reference value after indicating the recommendation content received by the mobile terminal having outputted the content recommendation request, the user mode presuming part generates the user mode value based on the designated individual reference value.

51. A content recommendation method for recommending contents based on a content recommendation request from a user, comprising:
a user mode presumption procedure for presuming an individual reference value about a predetermined individual presumption item based on a user context indicating a user situation included in the content recommendation request, and calculate a user mode value about a user mode presumption item;
a recommendation procedure for outputting a plurality of recommendation candidate contents extracted based on the user mode presumption item; and
a consolidating procedure for selecting and outputting as a recommendation content a predetermined number of contents from a plurality of the recommendation candidate contents.

52. The content recommendation method according to claim 51, wherein the user mode presuming procedure comprises:
a reference presumption procedure for presuming the individual reference value; and
a user mode generation procedure for calculating the user mode value about the user mode presumption item from a plurality of the individual reference values.

53. The content recommendation method according to claim 52, wherein
the reference presumption procedure presumes the individual reference value about the individual presumption item being different.

54. The content recommendation method according to claim 52, wherein
the user mode generation procedure generates the user mode value about the user mode presumption item based on a plurality of the individual presumption items.

55. The content recommendation method according to claim 51, wherein
the recommendation procedure adds a recommendation degree as a score when recommending contents according to the user mode value.

56. The content recommendation method according to claim 55, wherein
the recommendation procedure comprises a plurality of recommendation execution procedures to recommend contents, and a recommendation method used when recommending contents is set in advance as each recommendation execution procedure.

57. The content recommendation method according to claim 55, wherein the recommendation procedure comprising:
a recommendation execution procedure for recommending contents; and
a recommendation method setting procedure for setting a recommendation method when the recommendation execution procedure recommending contents according to the user mode presumption item.

58. The content recommendation method according to claim 55, wherein the recommendation procedure further comprises:
a plurality of recommendation execution procedures for recommending contents; and
a recommendation method setting procedure for setting a different recommendation method for each the recommendation execution procedure according to the user mode presumption item.

59. The content recommendation method according to claim 51 , wherein the consolidating procedure further comprises:
a selecting criteria setting procedure for setting a selecting criterion when selecting contents of a requested number of contents requested by a user from the recommendation candidate contents; and
a consolidation procedure for selecting and consolidate contents from the recommendation candidate contents according to the selecting criterion.

60. The content recommendation method according to claim 59, wherein
the selecting criteria setting procedure is setting to make the user mode be selected by, when making the user mode correlate with each area of an indexed table having a number of areas corresponding to a total number of the user modes, making the areas of a quantity corresponding to the user mode value correlate with the same user mode, and making random numbers of an integer be generated with an equally probability taking a total number of the user modes as a range.

61. The content recommendation method according to claim 59, wherein
the selecting criteria setting procedure is setting to, taking a product of the user mode value and the score given to a content as a selecting criterion, make a content with the selecting criterion being larger be selected.

62. The content recommendation method according to claim 51, wherein,
when the mobile terminal indicates the recommendation content, the consolidating procedure outputs the individual presumption item and the individual reference value with the recommendation content so that the individual presumption item and the individual reference value are also indicated.

63. The content recommendation method according to claim 62, wherein,
upon receiving the content recommendation request including the designated individual reference value corresponding to the individual reference value after indicating the recommendation content received by the mobile terminal having outputted the content recommendation request, the user mode presuming procedure generates the user mode value based on the designated individual reference value.

64. A computer-readable information recording medium recording a content recommendation program to recommend contents based on a content recommendation request from a user, the content recommendation program making a computer execute:
a user mode presumption step for presuming an individual reference value about a predetermined individual presumption item based on a user context indicating a user situation included in the content recommendation request, and calculate a user mode value about a user mode presumption item;
a recommendation step for outputting a plurality of recommendation candidate contents extracted based on the user mode presumption item; and
a consolidating step for selecting and output as a recommendation content a predetermined number of contents from a plurality of the recommendation candidate contents.

65. The information recording medium recording a content recommendation program according to claim 64, further comprising:
a recommendation step for adding a recommendation degree as a score when recommending contents according to the user mode value.

66. The information recording medium recording a content recommendation program according to claim 64, wherein the consolidating step further comprises:
a selecting criteria setting step for setting a selecting criterion when selecting contents of a requested number of contents requested by a user from the recommendation candidate contents; and
a consolidating step for selecting and consolidate contents from the recommendation candidate contents according to the selecting criterion.

67. The information recording medium recording a content recommendation program according to claim 66, wherein
the selecting criterion setting step is setting to make the user mode be selected by, when making the user mode correlate with each area of an indexed table having a number of areas corresponding to a total number of the user modes, making the areas of a quantity corresponding to the user mode value correlate with the same user mode, and making random numbers of an integer be generated with an equally probability taking a total number of the user modes as a range.

68. The information recording medium recording a content recommendation program according to claim 66, wherein
the selecting criteria setting step is a step to, taking a product of the user mode value and the score given to a content as a selecting criterion, make a content with the selecting criterion being larger be selected.

69. The information recording medium recording a content recommendation program according to claim 64, wherein,
when a mobile terminal indicates the recommendation content, the consolidating step outputs the individual presumption item and the individual reference value with the recommendation content so that the individual presumption item and the individual reference value are also indicated.

70. The information recording medium recording a content recommendation program according to claim 69, wherein,
upon receiving the content recommendation request including a designated individual reference value corresponding to the individual reference value after indicating the recommendation content received by the mobile terminal having outputted the content recommendation request, the user mode presuming step generates the user mode value based on the designated individual reference value.
